(19) United States
(12) Patent Application Publication
(10) Pub. No.: US 2023/0119516 A1
(43) Pub. Date: Apr. 20, 2023

(54) PROVIDING TEXT INFORMATION WITHOUT READING A FILE

(71) Applicant: International Business Machines Corporation, Armonk, NY (US)

(72) Inventors: Tohru Hasegawa, Tokyo (JP); Shunsuke Ishikawa, Tokyo (JP); Masaki Komedani, Yokohama-shi (JP); Yasumasa Kajinaga, Funabashi-shi (JP); Keisuke Nitta, Koshigaya-shi (JP); Daiki Tsuzuku, Kawasaki-shi (JP)

(21) Appl. No.: 17/451,494

(22) Filed: Oct. 20, 2021

(51) Int. Cl. G06F 16/14; G06F 16/16; G06F 16/13

(52) U.S. Cl. CPC G06F 16/14; G06F 16/164; G06F 16/13

(57) ABSTRACT

Determining the substantive text and image data that is included in a given file in a configurable file system without having to open the given file. The substantive text and image data included in the given file is determined primarily by analyzing the text meta-information that defines the given file.

### BACKGROUND

The present invention relates generally to the field of processing text information, and more particularly to processing text information that is saved in a file system across multiple format types.

The Wikipedia entry for “File System” (as of Apr. 9, 2021) states as follows: “In computing, a file system or filesystem . . . controls how data is stored and retrieved. Without a file system, data placed in a storage medium would be one large body of data with no way to tell where one piece of data stops and the next begins. By separating the data into pieces and giving each piece a name, the data is easily isolated and identified. Taking its name from the way paper-based data management system is named, each group of data is called a ‘file.’ The structure and logic rules used to manage the groups of data and their names is called a ‘file system.’”

### SUMMARY

According to an aspect of the present invention, there is a method, computer program product and/or system that performs the following operations (not necessarily in the following order): (i) providing a file system, with the file system including a plurality of files, and with each file of the plurality of files having an obtainable character data set, with the obtainable character data set including information indicative of text within a file; (ii) configuring the plurality of files within the file system so that the obtainable character data set can be analyzed as file attributes, with the file attributes being text meta-information; (iii) classifying the text meta-information based, at least in part, upon a document characteristic of the plurality of files; and (iv) responsive to the classification of the text meta-information, determining content contained within each given file of the plurality of files based upon the text meta-information.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a flowchart showing a second embodiment of a method according to the present invention;

FIG. 5 is a flowchart showing a third embodiment of a method according to the present invention;

FIG. 6 is a flowchart showing a fourth embodiment of a method according to the present invention; and

FIG. 7 is a flowchart showing a fifth embodiment of a method according to the present invention.

### DETAILED DESCRIPTION

Some embodiments of the present invention are directed towards determining the substantive text and image data that is included in a given file in a configurable file system without having to open the given file. The substantive text and image data included in the given file is determined primarily by analyzing the text meta-information that defines the given file.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

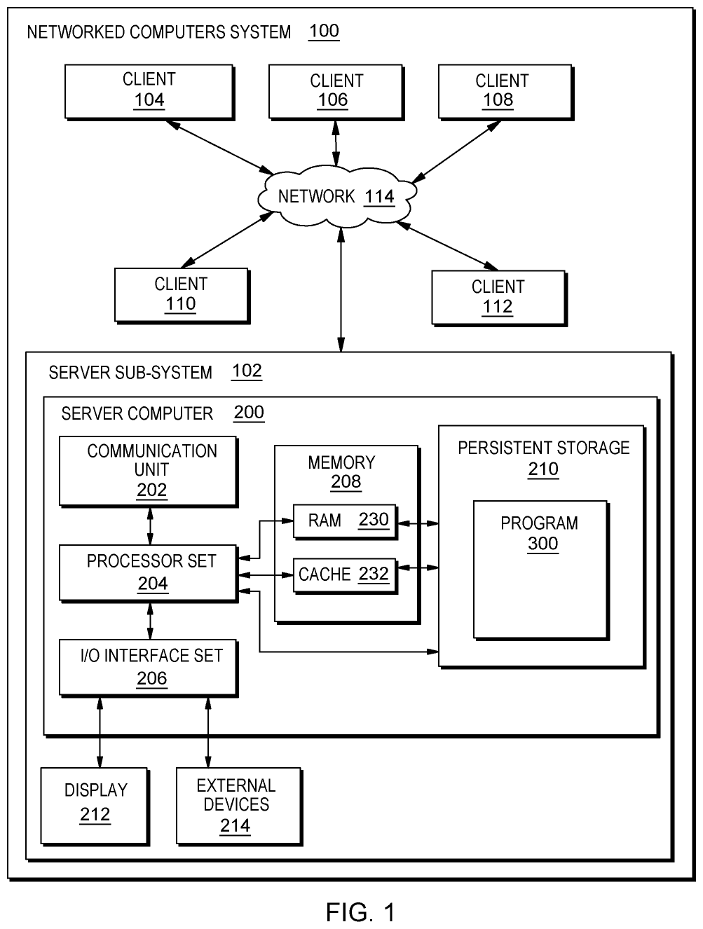

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

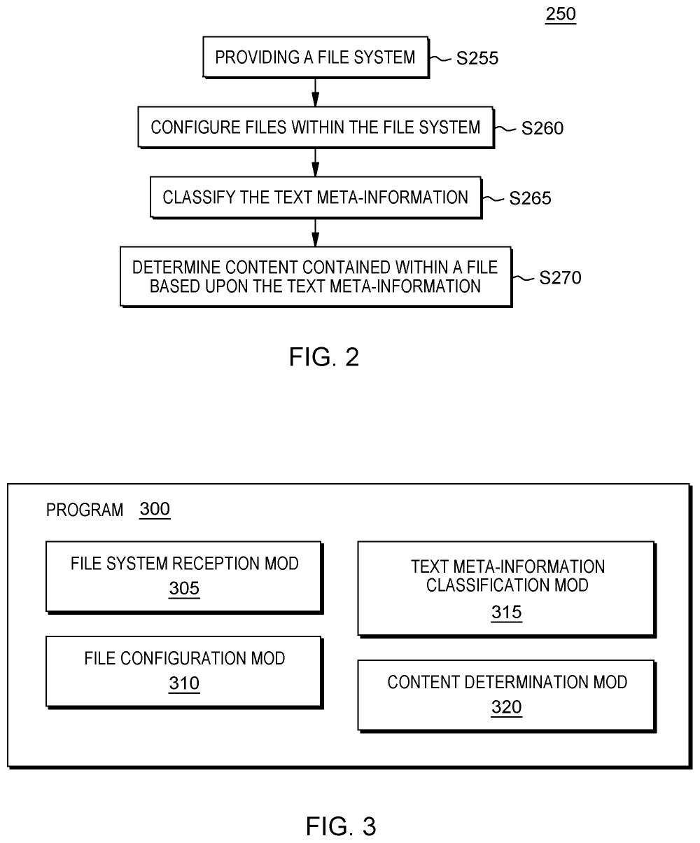

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where file system reception module (“mod”) 305 provides a configurable file system. In some embodiments, the configurable file system includes multiple files, with each file within the file system having an obtainable character data set (in other words, each file includes text related information and/or image related information).

Processing proceeds to operation S260, where file configuration mod 310 configures the configurable file system (discussed above in connection with operation S255, above) so that the text related information and/or image related information within the obtainable character data set can be analyzed as file attributes. In some embodiments, these file attributes are referred to as text meta-information.

Processing proceeds to operation S265, where text meta-information classification mod 315 takes the text meta-information (discussed in connection with operation S260, above) and classifies the text meta-information based upon a document characteristic of a file within the file system. In some embodiments, the document characteristic can include information that indicates the subject (topic) being discussed within a given file. Other document characteristics are discussed in Sub-Section III, below.

Processing finally proceeds to operation S270, where content determination mod 320 determines the content of a given file based upon the file's text meta-information. That is, content determination mod 320 determines the substantive text and/or image related information that is part of a given file's contents based upon the text meta-information that has been classified (as discussed in connection with operation S265, above). Essentially, content determination mod 320 “reads” the contents of the given file based solely on the text meta-information (that is, mod 320 reads the contents of the given file without opening the file itself).

### III. Further Comments and/or Embodiments

With respect to the state of the current art, certain types of information about a file saved in a file system, such as the amount of information of a text included in the file, the language in which the text is written, and the subject matter of the text cannot be determined until the file is opened to display the content contained therein.

In particular, a file that is in a binary format such as PDF or .docx may include not only text information but also information represented by images. This type of binary file may include many images and have a large file size even with only a small amount of text information.

When accessing a file system located on a remote site, opening a file that is different from an expected file repeatedly is potentially problematic because this action may increase the number of network packets.

Conventionally, accessibility to a file is determined on the basis of the right of access to the file. This typically cannot be used when preventing access to a file including a specific keyword. For example, when backup software is used to copy files to external storage, the files that are potentially to be copied need to be made accessible from the backup software. There are cases where it is preferable to avoid backing up files including a specific keyword (such as personal information) to external storage. In such a case, it is necessary to check the content of the files and assign access permissions to the files. A person creating a file can set the access permissions to the file taking into account the content thereof. However, a backup method for the file is not always established at the time of creating the file. For example, there is a case where backup was made to an in-house NAS and to cloud storage for redundancy purposes. In such a case, permission is required to back up to the cloud storage, and if this permission was not present at the time of creating the file, then this permission needs to be set to the file as an access permission.

Some embodiments of the present invention may include one, or more, of the following features, characteristics and/or advantages: (i) configures a file system to analyze information obtainable from character information included in a file; and (ii) makes the analyzed information accessible as file attributes (hereinafter, the analyzed information is referred to as text meta-information).

In some embodiments of the present invention, the text meta-information includes the following: (i) the language of the text included in the file; (ii) the number of the words in the text included in the file; (iii) the number of the sentences in the text included in the file; (iv) the number of the nouns recognized as a result of natural language processing applied to the text included in the file; and (v) the name of the category obtained by classification of the text using a document classification technique. These file attributes are made accessible, for example, as extended attributes via a general API.

Making the above-described text meta-information accessible as file attributes makes it possible to guess the content of the files to some degree without actually reading out the files. Specifically, checking the file attributes makes it possible to avoid cases where a file is opened only to find that the file has been written in an unreadable foreign language or the file mostly contains images and contains only a small amount of text information. Additionally, a more practical usage example may be a filer like Explorer that is capable of varying the icons of the files and/or presenting files in the order of the number of words. Also, for the purposes of judging access controls to files, it is possible to allow only a specific process to access a file when a specific keyword is included in the file.

Some embodiments of the present invention may include one, or more, of the following features, characteristics and/or advantages: (i) can be carried out by extending a general file system; (ii) normal file systems save information representing which locations the files have been written in the storage as well as meta-information such as file name and timestamp, as data called Index, separately from the data of the files; and (iii) a normal file system is extended to add text meta-information to the meta-information.

In this embodiment, the text meta-information is information extracted from text and includes the same types of text meta-information described above. Examples of the classification types includes: classification by topic of the document, classification by sentiment, and/or classification by whether personal information is included.

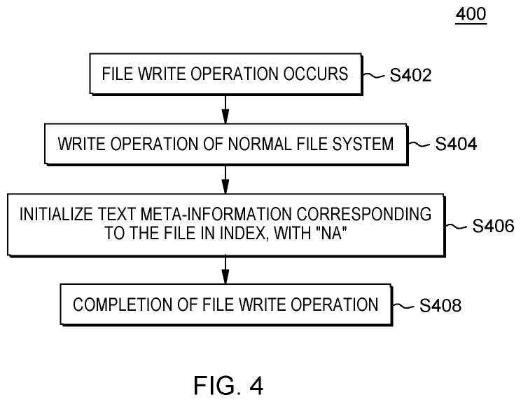

In some embodiments of the present invention, when a file write operation occurs, initialization of text meta-information in an Index is performed as shown by the method described in flowchart 400 of FIG. 4 in addition to the normal file write operation.

The method described in flowchart 400 includes the following operations (not necessarily shown in the following order): (i) file write operation occurs (operation S402); (ii) write operation of a normal file system (operation S404); (iii) initialize text meta-information corresponding to the file in the Index with a “NA” designation (operation S406); and (iv) complete the file write operation (S408).

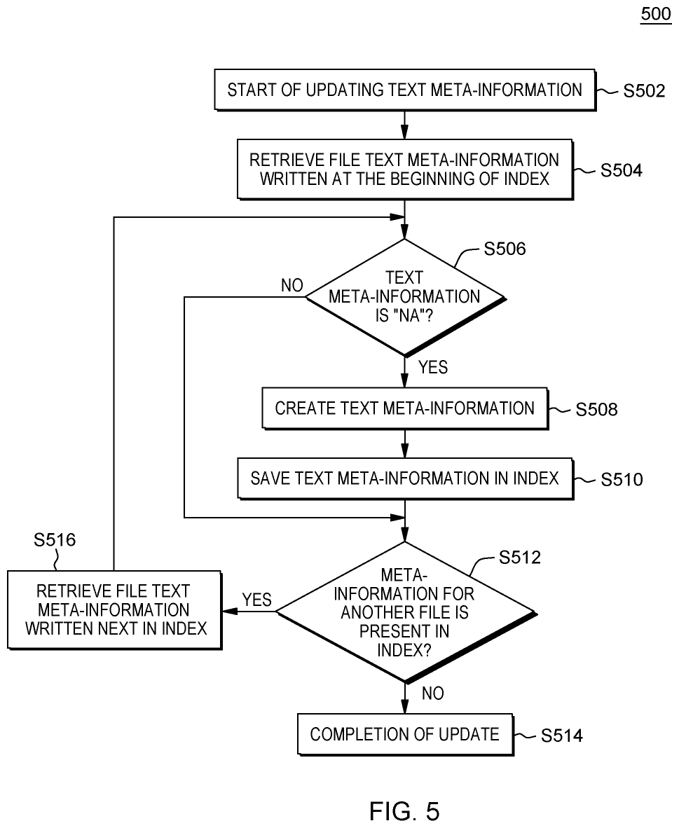

The text meta-information is created asynchronously with the file write operation as shown in flowchart 500 of FIG. 5 by first analyzing the data part of the file, and then by updating the Index. To extract text information, software like Apache Tika can be used to determine the type of a file and extract text from a binary file like a PDF or Word file. To count the number of words in the extracted text and/or to count the number of nouns by performing natural language processing on the extracted text, existing techniques can be used. (Note: the term(s) “APACHE” and/or “TIKA” may be subject to trademark rights in various jurisdictions throughout the world and are used here only in reference to the products or services properly denominated by the marks to the extent that such trademark rights may exist.)

Processing the operations of flowchart 500 begins by updating text meta-information (operation S502). Processing proceeds to operation S504 where a text meta-information file that is written at the beginning of the Index is retrieved. Processing then proceeds to operation S506, where embodiments of the present invention determines whether the text meta-information is “NA.” If the text meta-information is “NA” (that is, not yet processed), then processing proceeds to operation S508 where the text meta-information is created. If the text meta-information is not “NA,” then processing proceeds to operation S512 (discussed in greater detail below).

Processing proceeds to operation S510 where the text meta-information is saved in the Index. Processing then proceeds to operation S512, where embodiments of the present invention determine whether or not meta-information for another file is present in the Index. If the text meta-information for another file is present in the Index, then processing proceeds to operation S516 where the file containing the text meta-information written in the Index is retrieved. If the text meta-information for another file is not present in the Index, then processing proceeds to operation S514 where the update is completed.

In this way, text meta-information can be updated asynchronously with file creation operations. In some embodiments, this update operation (operation S514) can be carried out regularly (such as once per hour) or may be carried out each time a file is written or may be carried out when the number of created files reaches a certain number (such as when 5 files have been written).

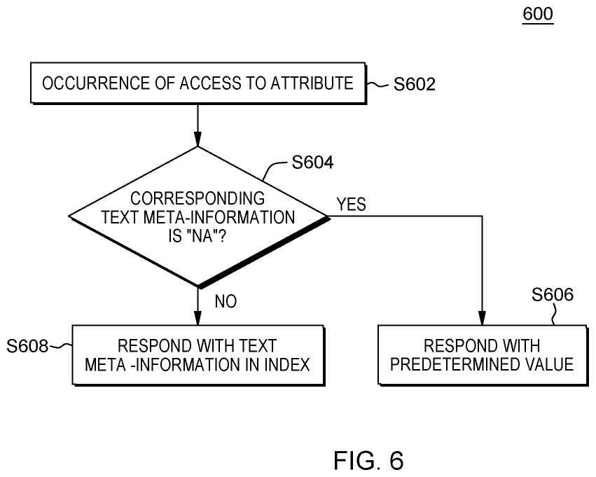

In some embodiments, the text meta-information is made accessible as file attributes. This process is shown in flowchart 600 of FIG. 6. In some embodiments, the text meta-information can be made accessible via an Extended Attribute with a specific name (such as “Language, NumOfWords, NumOfSentences”).

Processing the operations of flowchart 600 begins at operation S602, where a first attribute is accessed. Processing proceeds to operation S604, where it is determined whether the corresponding text meta-information is “NA.” If the corresponding text meta-information is “NA,” then processing proceeds to operation S606 where a predetermined value is provided as a response. If the corresponding text meta-information is not “NA,” then processing proceeds to operation S608 where the text meta-information in the Index is provided as a response.

In some embodiments, the predetermined value can be “UNKNOWN” for some attributes (such as Language, Category) and/or represented by characters and may be “−1” for attributes (such as NumOfWords, NumOfSentences) represented by a number.

In some embodiments, allowing the text meta-information to be accessed as file attributes in this way makes it possible to guess the content of files to some degree without actually reading out the files. For example, a filer like Explorer can be configured to vary the icons of files in a manner that depends on the classified categories or with the languages and/or to present the files in the order of the number of words.

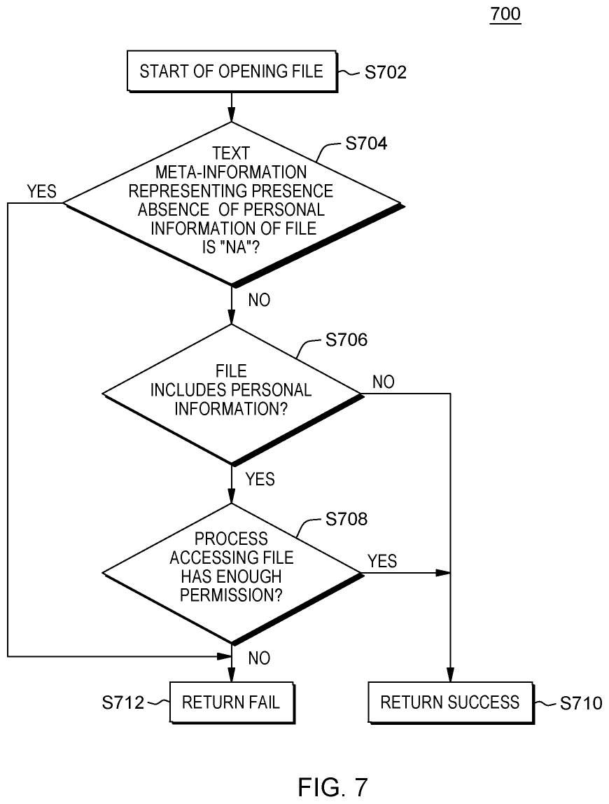

Additionally, a file access control depending on the content of files can be implemented such that files including personal information are made accessible only from specific applications (from certain processes). This can be implemented by saving text meta-information as a result of: (i) performing document classification as to whether a file has personal information, and by (ii) determining, using the text meta-information, whether to cause a file open operation to succeed to open the file. This process is shown in flowchart 700 of FIG. 7 (and discussed in greater detail below).

In particular, returning “Fail” in the cases of “NA” prevents access to a file during the time period from when the file is created until when the file is determined as having no personal information. This method is effective in preventing information leakage compared to a method such that text meta-information of a file is extracted and added to the metadata of the file in an operation outside the file system. This is because the access control can be immediately carried out in the event of file creation/update.

Processing the operations of flowchart 700 begins at operation S702 where a file is initially opened. Processing proceeds to operation S704 where it is determined whether the text meta-information representing the presence or absence of personal information is “NA.” If it is determined that the text meta-information representing the presence/absence of personal information is “NA,” then processing proceeds to operation S712 where a “fail” indication is returned. If it is not determined that the text meta-information representing the presence/absence of personal information is “NA,” then processing proceeds to operation S706. At operation S706, it is determined whether or not the given file from operation S702 includes personal information. If it is determined that the file does not include personal information, then processing proceeds to operation S710, where a “success” indication is returned.

If it is determined that the file includes personal information, then processing proceeds to operation S708 where it is determined whether the process to access the file has sufficient permission safeguards. If the determination at operation S708 is yes, then a “success” indication is returned. If the determination at operation S708 is no, then a “fail” indication is returned.

Typically, there are applications that read out a file in a file system and analyze text information of the file. In a case where such an external application is to be used, it is necessary to make an inquiry to the external application to access the text information. In other words, it is necessary to use a method different from the standard file access method.

In contrast, embodiments of the present invention make the text meta-information accessible as file attributes and thereby allows accessing text meta-information using a general API of the file system (such as an API for accessing Extended Attributes).

Moreover, as the text meta-information of a file suggests the content of the file, the use of an external application necessitates access control similar to the control by file access permissions. According to embodiments of the present invention, as the text meta-information is saved as file attributes, the access control implemented in the file system can be applied as is and thus no special access control needs to be implemented.

Additionally, when using an external application, it is difficult to modify that access control in a file creation/update operation in an atomic manner. In some embodiments, the term “atomic manner” means that the operation cannot be split to multiple smaller operations. For example, assume that there are three small steps or operations to update a file and update text-metainformation, such as: (1) open the file, (2) write date for the file, and (3) update text-meta information as “NA.”

If embodiments of the present invention use external applications and a typical filesystem (such as ext3 on Linux or NTFS on Windows), then the external application should call corresponding filesystem API as follows: (a) open the file, (b) write data, and (c) update metadata. Here, it is possible the other application (such as a backup software) accesses the file between operations (b) and (c). Performing these operations in an “atomic manner” means that operations (2) and (3) are performed as a single operation. Therefore, when an application calls for (b), then embodiments of the present invention's filesystem will perform operations (2) and (3). (Note: the term(s) “LINUX,” “NTFS” and/or “WINDOWS” may be subject to trademark rights in various jurisdictions throughout the world and are used here only in reference to the products or services properly denominated by the marks to the extent that such trademark rights may exist.)

Consider a case in which backup software is prevented from accessing files including personal information, and a file determined by the external application as having no personal information is updated to include personal information. In this case, it is possible that the backup software accesses the file during the time period until when the external application next determines the presence/absence of personal information. The method of the present invention sets the text meta-information of a file to “NA” when the file is updated and thus prevents the file from being accessed until when the presence/absence of personal information is determined. As a result, the possibility of information leakage is eliminated.

Typically, a filer like Explorer can be configured to vary icons of files on the basis of the classified categories and/or present the files in the order of the number of words. An access control can be implemented according to the content of files to prevent leakage of personal information and/or classified information.

Some embodiments of the present invention have been described as being configured to create text meta-information from character information by way of example. However, the meta-information is not necessarily limited to one extracted from character information. For example, files can be classified using the images and videos included in the files and the classification result may be used as meta-information.

Additionally, it is conceivable to modify the embodiment so that a file including an image in which a specific person or animal is drawn is given the name of that person or animal as meta-information and that meta-information may be presented before the file is opened, and a file including an image of the logo or signature of a company may be given of that information as meta information and the meta-information may be used for access control.

Some embodiments of the present invention provide a method for accessing meta-information of a file in an operating system as a file attribute of the file, the meta-information being obtainable from character information included in the file, and the file attribute being readable via an API of the operating system.

Operations of this method include at least the following (not necessarily in the following order): (i) initializing meta information of a file, the step of initializing including detecting a file write operation of a file system of the operating system, and initializing meta-information of the file in an Index with a predetermined value; (ii) updating the meta-information of the file, the step of updating including retrieving, as a file attribute, the meta-information recorded in the Index for the file, and when the file attribute is the predetermined value, creating meta-information of the file and saving the created meta-information in the Index; and (iii) accessing the file attribute without reading content of the file, the step of accessing including determining whether the meta-information of the file is the predetermined value, returning a predetermined value when the result of the determination is positive, and returning the meta-information recorded in the Index when the result of the determination is negative.

Some embodiments of the present invention provide a method for controlling access to a file that includes personal information. Operations of this method include at least the following (not necessarily in the following order): (i) detecting a file open operation to access a file from an application; (ii) determining whether the file includes personal information as a file attribute; (iii) allowing the application to access the file when the application has a permission to access personal information; and (iv) disallowing the application to access the file when the application does not have the permission to access personal information.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method comprising:
providing a file system, with the file system including a plurality of files, and with each file of the plurality of files having an obtainable character data set, with the obtainable character data set including information indicative of text within a file;
configuring the plurality of files within the file system so that the obtainable character data set can be analyzed as file attributes, with the file attributes being text meta-information;
classifying the text meta-information based, at least in part, upon a document characteristic of the plurality of files; and
responsive to the classification of the text meta-information, determining content contained within each given file of the plurality of files based upon the text meta-information.

2. The method of claim 1 wherein the document characteristic includes information indicative of personal identifiable information (PII) being present in a given file of the plurality of files.

3. The method of claim 1 wherein the document characteristic includes information indicative of a topic of a given file of the plurality of files.

4. The method of claim 1 wherein text meta-information includes information indicative of language used in the text of a given file of the plurality of files.

5. The method of claim 1 wherein text meta-information includes information indicative of a number of words included in the text of a given file of the plurality of files.

6. The method of claim 1 wherein text meta-information includes information indicative of a name of a category of a given file of the plurality of files that is obtained through use of a document classification technique.

7. A computer program product (CPP) comprising:
a machine readable storage device; and
computer code stored on the machine readable storage device, with the computer code including instructions and data for causing a processor(s) set to perform operations including the following:
providing a file system, with the file system including a plurality of files, and with each file of the plurality of files having an obtainable character data set, with the obtainable character data set including information indicative of text within a file,
configuring the plurality of files within the file system so that the obtainable character data set can be analyzed as file attributes, with the file attributes being text meta-information,
classifying the text meta-information based, at least in part, upon a document characteristic of the plurality of files, and
responsive to the classification of the text meta-information, determining content contained within each given file of the plurality of files based upon the text meta-information.

8. The CPP of claim 7 wherein the document characteristic includes information indicative of personal identifiable information (PII) being present in a given file of the plurality of files.

9. The CPP of claim 7 wherein the document characteristic includes information indicative of a topic of a given file of the plurality of files.

10. The CPP of claim 7 wherein text meta-information includes information indicative of language used in the text of a given file of the plurality of files.

11. The CPP of claim 7 wherein text meta-information includes information indicative of a number of words included in the text of a given file of the plurality of files.

12. The CPP of claim 7 wherein text meta-information includes information indicative of a name of a category of a given file of the plurality of files that is obtained through use of a document classification technique.

13. A computer system (CS) comprising:
a processor(s) set;
a machine readable storage device; and
computer code stored on the machine readable storage device, with the computer code including instructions and data for causing a processor(s) set to perform operations including the following:
providing a file system, with the file system including a plurality of files, and with each file of the plurality of files having an obtainable character data set, with the obtainable character data set including information indicative of text within a file,
configuring the plurality of files within the file system so that the obtainable character data set can be analyzed as file attributes, with the file attributes being text meta-information,
classifying the text meta-information based, at least in part, upon a document characteristic of the plurality of files, and
responsive to the classification of the text meta-information, determining content contained within each given file of the plurality of files based upon the text meta-information.

14. The CS of claim 13 wherein the document characteristic includes information indicative of personal identifiable information (PII) being present in a given file of the plurality of files.

15. The CS of claim 13 wherein the document characteristic includes information indicative of a topic of a given file of the plurality of files.

16. The CS of claim 13 wherein text meta-information includes information indicative of language used in the text of a given file of the plurality of files.

17. The CS of claim 13 wherein text meta-information includes information indicative of a number of words included in the text of a given file of the plurality of files.

18. The CS of claim 13 wherein text meta-information includes information indicative of a name of a category of a given file of the plurality of files that is obtained through use of a document classification technique.
